(19) United States
(12) Patent Application Publication
(10) Pub. No.: US 2014/0185136 A1
(43) Pub. Date: Jul. 3, 2014

(54) MULTI DIRECTIONAL ILLUMINATION FOR A MICROSCOPE AND MICROSCOPE

(71) Applicant: KLA-Tencor Corporation, Milpitas, CA (US)

(72) Inventors: Christophe WOUTERS, Balen (BE); Steven M.W. BOEYKENS, Heverlee (BE); Paul M.J. VERSTREKEN, Boutersem (BE)

(73) Assignee: KLA-Tencor Corporation, Milpitas, CA (US)

(21) Appl. No.: 14/199,404

(22) Filed: Mar. 6, 2014

Related U.S. Application Data
(63) Continuation of application No. PCT/US2013/057046, filed on Aug. 28, 2013.
(60) Provisional application No. 61/693,966, filed on Aug. 28, 2012.

(51) Int. Cl. G02B 21/08; G02B 21/10

(52) U.S. Cl. CPC G02B 21/08; G02B 21/10
USPC 359/381; 359/385; 359/387

(57) ABSTRACT

A dome illumination for a microscope and a microscope are disclosed. At least one objective lens carries a dome at a free end, wherein the free end of the objective lens is facing a surface of the object. At least one light source is arranged such that an illumination is provided to the dome when the objective lens is positioned in an optical axis or working position of the microscope.

### CROSS-REFERENCE TO RELATED APPLICATIONS

This application is a Continuation of International Patent Application Serial No. PCT/US2013/057046, filed on Aug. 28, 2013, which application claims priority of U.S. Provisional Patent Application No. 61/693,966, filed on Aug. 28, 2012, which applications are incorporated herein by reference in their entireties.

### FIELD OF THE INVENTION

The present invention relates to an illumination for a microscope.

Additionally, the present invention relates to microscope.

### BACKGROUND OF THE INVENTION

The British Patent Application GB 408899 A shows a stand in the form of a spherical dome having its centre in the surface to be examined. The dome rests with feet on the surface. A tube screwed into an aperture in the dome carries the illumination parts consisting of a lamp and lenses.

The Japanese Patent Application JP 201163954 A describes a wire surface defect detection system. The wire surface defect detection system radiates light to the surface of the wire and searches for a flaw in the wire surface with a camera. The camera is arranged perpendicularly to and above the wire surface. A dome member is disposed between the camera and the wire. The inner surface of the dome member is a reflecting surface, and light sources for radiating light toward the camera side and uniformly radiating light having been reflected on the reflecting surface to the wire surface are disposed at a constant interval inside the lower opening end of the dome member.

The US Patent Application US 2010/208980 A1 discloses an apparatus for inspecting a semiconductor wafer. A plurality of light sensors is arranged relative to a light source and the wafer inspection platform. Consequently, images of different angle views of a surface of the wafer can be received and compared with corresponding images taken of a reference wafer. The light sensors may receive superposed images of light reflected directly from the light source of the wafer surface and light indirectly reflected of the wafer surface after first reflecting on a dome with a diffusely reflecting inner surface positioned over the platform.

An illumination device for visual inspection is disclosed in the US Patent Application US 2010/246174 A1. A transmissive reflector plate that is formed of a light transmitting material and has an opening in a center. The reflector has a dome shape, a radius of which is gradually expanded downward and with an opening in a center. The dome has a lower surface formed as a reflecting surface on which fine unevenness for diffusing and reflecting light from below is formed. An upper surface is located on an opposite side of the lower surface. A first, second, and third light source unit, that irradiate light on an inspection object, wherein the first, second, and third light source units being provided on the upper surface of the transmissive reflector plate and arranged in a place below the opening. A fourth light source unit that irradiates light on the inspection object and being provided below the transmissive reflector plate.

From the discussion of the prior art above, it is evident, that in general dome illumination is used to illuminate objects with complex shapes. Image artefacts related to the topography of this kind of objects (shadows, bright and dark spots) will be reduced significantly by the dome illumination. The general concept is that light sources are located at the bottom in order to illuminate the inside of the dome. The inside of the dome is covered with a highly reflective and diffuse material which scatters the light. The scattered light will eventually illuminate the object. The imaging system looks through a hole in the center of the top of the dome towards the object. The most important property of this illumination is that it strikes the object at multiple angles hence reducing shadows and hotspots.

One disadvantage of the prior art design is that a dome cannot be used on a microscope. First of all the working distance of a microscope is short (less than 20 mm). The dome should fit between the object and the objective lens which means the height of the dome should also be less than 20 mm. All commercially available domes have larger sizes.

### BRIEF SUMMARY OF THE INVENTION

It is an object of the invention to provide illumination for a microscope which creates the opportunity to do inspections on objects with complex shapes, wherein due to the illumination image artefacts related to the topography of this kind of objects (shadows, bright and dark spots) are reduced.

The above object is achieved by an illumination for a microscope comprising:
at least one objective lens defining a free end which is facing a surface of an object;
a dome is mounted to the free end of the at least one objective lens; and
at least one light source is arranged such that an illumination is provided to the dome when the objective lens is positioned in an optical axis of the microscope, which is the operative position.

A further object of the invention to provide a microscope, which has an illumination enabling inspections on objects with complex shapes, wherein due to the illumination image artefacts related to the topography of this kind of objects (shadows, bright and dark spots) are reduced.

The above object is achieved by a microscope comprising:
a microscope turret carrying at least one objective lens, wherein the at least one objective lens is movable with the microscope turret into an optical axis of the microscope;
a dome, mounted to a free end of the at least one objective lens; and
an external light source arranged such that external light is provided to the dome when the objective lens is positioned in an optical axis of the microscope, which is the operative position.

According to an advantageous embodiment the objective lens has a ring shaped mirror which is arranged in a dark field illumination path of the objective lens. A reflective surface of the ring shaped mirror is formed such that incident light from the at least one light source is reflected towards an inner surface of the dome. The inner surface of the dome is coated with some highly reflective diffuse material and formed such, that the light is scattered towards the object. Beside the at least one light source for providing light in the dark field mode, an additional light source is arranged such that light from the additional light source shines under the dome onto the surface of the object. It is advantageous if the additional light source is a ring light.

The material of the dome is made from a highly reflective and diffuse material.

Another embodiment of the invention is, that the at least one light source is an external light source being arranged such that an external light impinging on the dome is scattered towards the object. The dome is made of transparent diffuse material.

According to a further embodiment, the at least one light source is an external light source which is arranged such that an external light impinging on the dome is scattered towards the object and the dome is made of a wavelength converting material.

The external light source is a ring light with at least one LED with a wavelength band λₑₓ±Δλₑₓ. The wavelength converting material of the dome provides a wavelength band λₑₘ±Δλₑₘ for the illumination of the object, wherein λₑₘ±Δλₑₘ≢λₑₓ±Δλₑₓ.

According to a further embodiment of the invention the at least one light source is an external light source being arranged such that an external light impinging on the dome is refracted towards the object and the dome is made of a transparent material with multiple facets. Each facet has a refracting power in order to refract part of the impinging beam of external light towards the object. The facets are formed on an outside of the dome or on an inside of the dome. Here the external light source is as well a ring light.

The inventive microscope has an internal light source which provides light to a ring shaped mirror arranged in a dark field illumination path of the objective lens. A reflective surface of the ring shaped mirror is formed such that incident light from the at least one internal light source is reflected towards an inner surface of the dome. The inner surface of the dome is coated with some highly reflective diffuse material and formed such that the light is scattered towards the object. The dome is coated with some highly reflective diffuse material. An external light source, in the form of a ring light can be arranged such that light from the ring light shines under the dome onto the surface of the object.

According to another embodiment the dome is made of transparent diffuse material. The external light source is arranged such that an external light impinging on the dome of the objective lens is scattered towards the object. Another embodiment is that the dome is made of a wavelength converting material for converting a wavelength band λₑₓ±Δλₑₓ of the external light to a wavelength band λₑₘ±Δλₑₘ for the illumination of the object, wherein λₑₘ±Δλₑₘ≢λₑₓ±Δλₑₓ.

According to another embodiment the external light is arranged such that an external light impinges on the dome. The dome is made of a transparent material with multiple facets wherein each facet has a refracting power in order to refract part of the impinging beam of external light towards the object.

The invention makes it possible to provide a dome which is sufficiently small that it can be used on a microscope. Different objective lenses on the microscope turret will have different working distances and fields of view. Basically this means that each lens requires its own dome and an illumination for the dome. The only way to achieve this would be mounting the dome on the objective lens so that the dome and objective lens move together whenever the microscope turret is rotated.

All the embodiments of the dome described herein have the advantage that the light source is not integrated in the dome. Because of this it is possible to create smaller domes which can be mounted on the objective lens of a microscope. A second benefit of the light source not being integrated in the dome is that no cabling is required. This makes it possible to mount the dome on a microscope turret without ending up with bungled cables.

In case of the embodiment with multiple facets, there is an additional benefit in the available degrees of freedom for the design. This gives high control over the resulting light distribution. On top of that this dome relies on refraction rather than scattering. This makes it more efficient resulting in higher illumination levels.

### BRIEF DESCRIPTION OF THE DRAWINGS

The nature and mode of operation of the present invention will now be more fully described in the following detailed description of the invention taken with the accompanying drawing figures, in which

FIG. 1 is a schematic view of a microscope turret with plurality of objective lenses mounted on the turret;

FIG. 2 is an objective lens, wherein the illumination for the dome is provided via a dark field illumination path of the objective lens;

FIG. 3 shows how the light from the dark field illumination path is spread on the inner surface of the dome;

FIG. 4 is a further embodiment of the invention, wherein from an additional light source further illumination shines under the dome onto a surface of an object;

FIG. 5A is a representation of the angular distribution of the illumination at the object illuminated with a dome and ring light as shown in FIG. 4;

FIG. 5B is a representation of the illumination at the object illuminated with a dome and ring light as shown in FIG. 4;

FIG. 6 is an objective lens, wherein the illumination for the object is provided through the dome;

FIG. 7 is a further embodiment of the illumination arrangement shown in FIG. 6;

FIG. 8 is an angular illumination profile of the embodiments shown in FIG. 2, FIG. 6 and FIG. 7;

FIG. 9 is an embodiment of the invention, wherein the dome has multiple refractive facets;

FIG. 10 is the resulting angular illumination profile of the embodiment shown in FIGS. 9; and

FIG. 11 is an embodiment of the arrangement of a ring light with respect to the objective lenses mounted on a turret of a microscope.

### DETAILED DESCRIPTION OF THE INVENTION

In the following description, numerous specific details are set forth in order to provide a thorough understanding of the present invention. The present invention may be practiced without some or all of these specific details. In other instances, well known process operations have not been described in detail to not unnecessarily obscure the present invention. While the invention will be described in conjunction with the specific embodiments, it will be understood that it is not intended to limit the invention to the embodiments.

Same reference numerals refer to the same elements throughout the various figures. Furthermore, only reference numerals necessary for the description of the respective figure are shown in the figures. The shown embodiments represent only examples of how the invention can be carried out. This should not be regarded as limiting the invention.

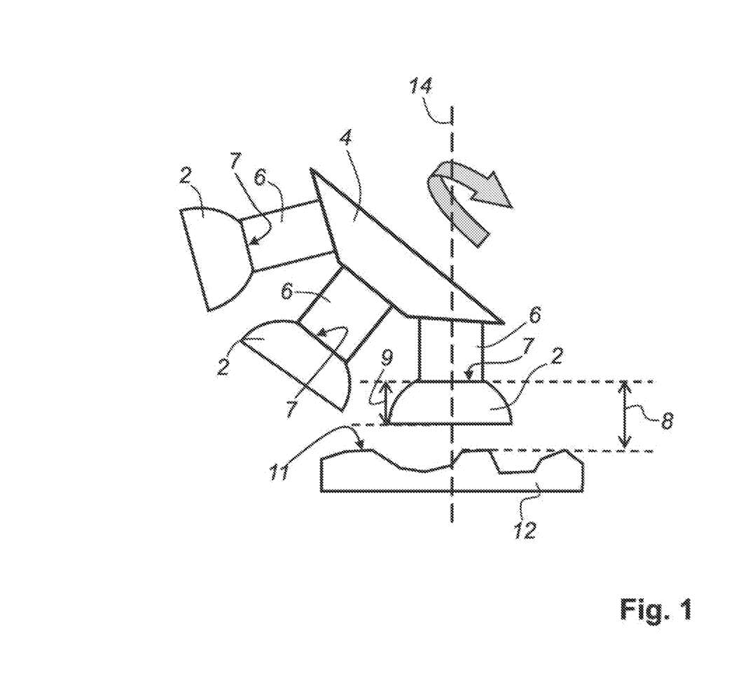

FIG. 1 is a schematic view of a microscope turret 4 with plurality of objective lenses 6 mounted on the microscope turret 4. Since a working distance 8 of a microscope 10 (see FIG. 11) is short, typically less than 20 mm, each objective lens 6 carries a dome 2. The dome 2 is attached to a free end 7 of an objective lens 6 and the dome 2 fits between a surface 11 of an object 12 and the objective lens 6. Consequently, the dome 2 is restricted in height 9, which is less than the working distance 8.

The dome 2 according to the invention is sufficiently small so that it is feasible to use it on the microscope 10. The microscope turret 4 carries different types of objective lenses 6 each of which has different working distance and a field of view (not shown). This means that each objective lens 6 requires its own dome 2 and its own illumination. A specific dome 2 is mounted on each objective lens 6 so that the dome 2 and objective lens 6 move together in an to optical axis 14 of the microscope 10 (see FIG. 11) when the microscope turret 4 is rotated.

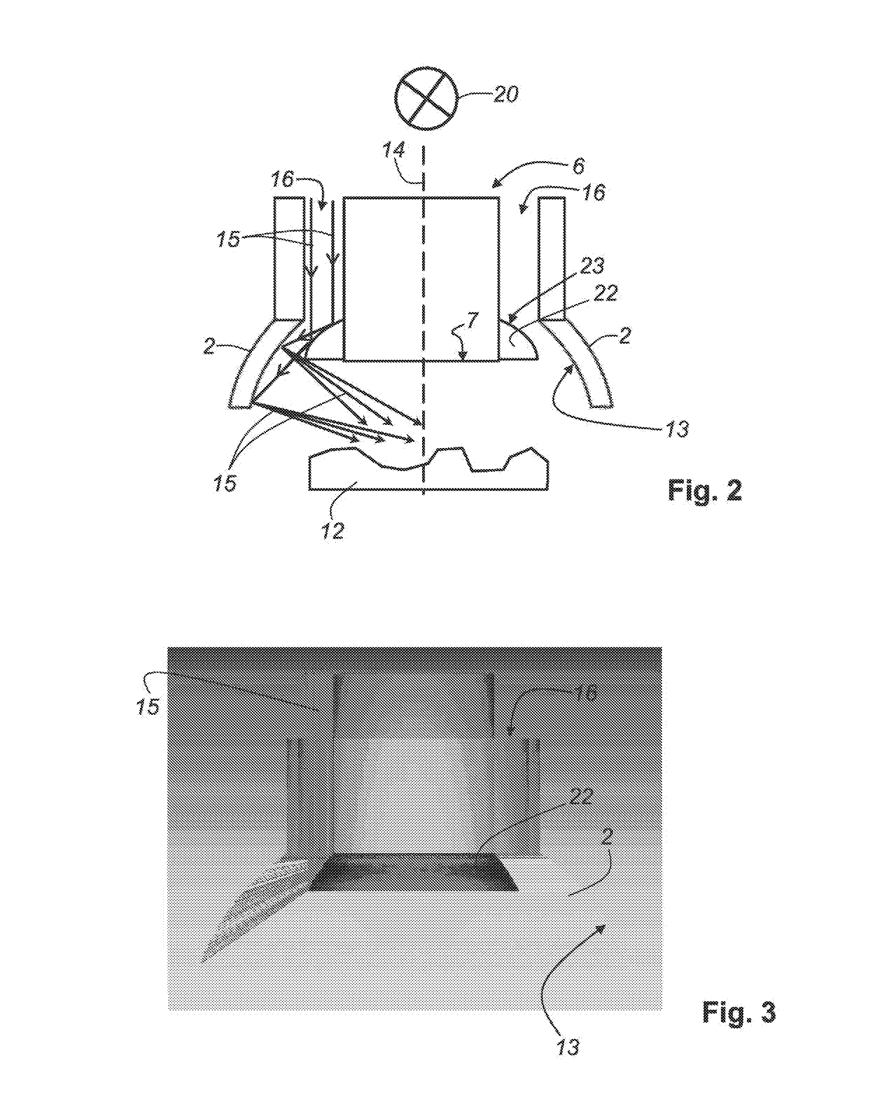

In FIG. 2 an objective lens 6 is shown which has a dark field illumination path 16. The at least one light source 20 is arranged such that light 15 from the at least one light source 20 is provided to an inner surface 13 of the dome 2 via the dark field illumination path 16 of the objective lens 6. A ring shaped mirror 22 is mounted to the free end 7 of the objective lens 6. Light 15 from the dark field illumination path 16 strikes a reflective surface 23 of the ring shaped mirror 22. The reflective surface 23 of the ring shaped mirror 22 is formed such that the incident light 15 is reflected towards the reflective inner surface 13 of the dome 2. The inner surface 13 of the dome 2 is coated with some highly reflective diffuse material which scatters the light 15 towards the object 12.

FIG. 3 shows how the light 15 form the dark field illumination path 16 is spread on the inner surface 13 of the dome 2. The ring shaped mirror 22 fans out the incident light 15 so that the inner surface 13 of the dome is evenly illuminated.

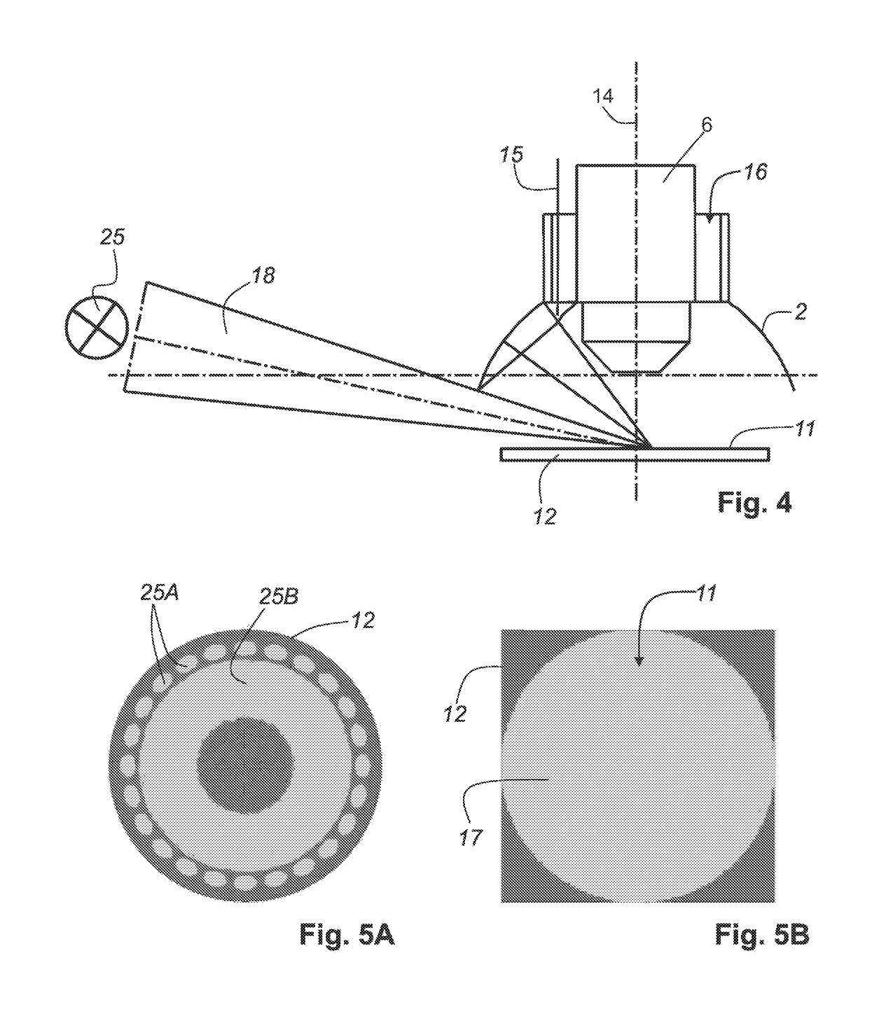

A further embodiment of the invention is shown in FIG. 4, wherein an external light source 25 is provided. The external light source 25 shines external light 18 in addition to the light 15 form the dark field illumination path 16 of the objective lens 6 under the dome 2 onto the surface 11 of the object 12. The objective lens 6 is positioned in the optical axis 14. When the additional light source 25 (configured as a ring light) is also switched on, the illumination covers a larger angular range. The dome is made from highly reflective and diffuse material.

FIG. 5A shows the angular distribution of the illumination at the object 12 which is illuminated with the additional light source 25 configured as a ring light which illuminates the dome 2. The ring light is arranged such that it surrounds the dome 2 when the respective objective lens 6 is in an operative position. As a result one receives light spots at 25A which surround a homogeneous illuminated ring 25B.

FIG. 5B shows the illumination at the object 12 which is illuminated with the additional light source 25 configured as a ring light together with light source 20 which illuminates the dome 2. The ring light is arranged such that it surrounds the dome 2 when the respective objective lens 6 is in an operative position. As a result one obtains a homogeneous illumination of the field of view 17 on the surface 11 of the object 12.

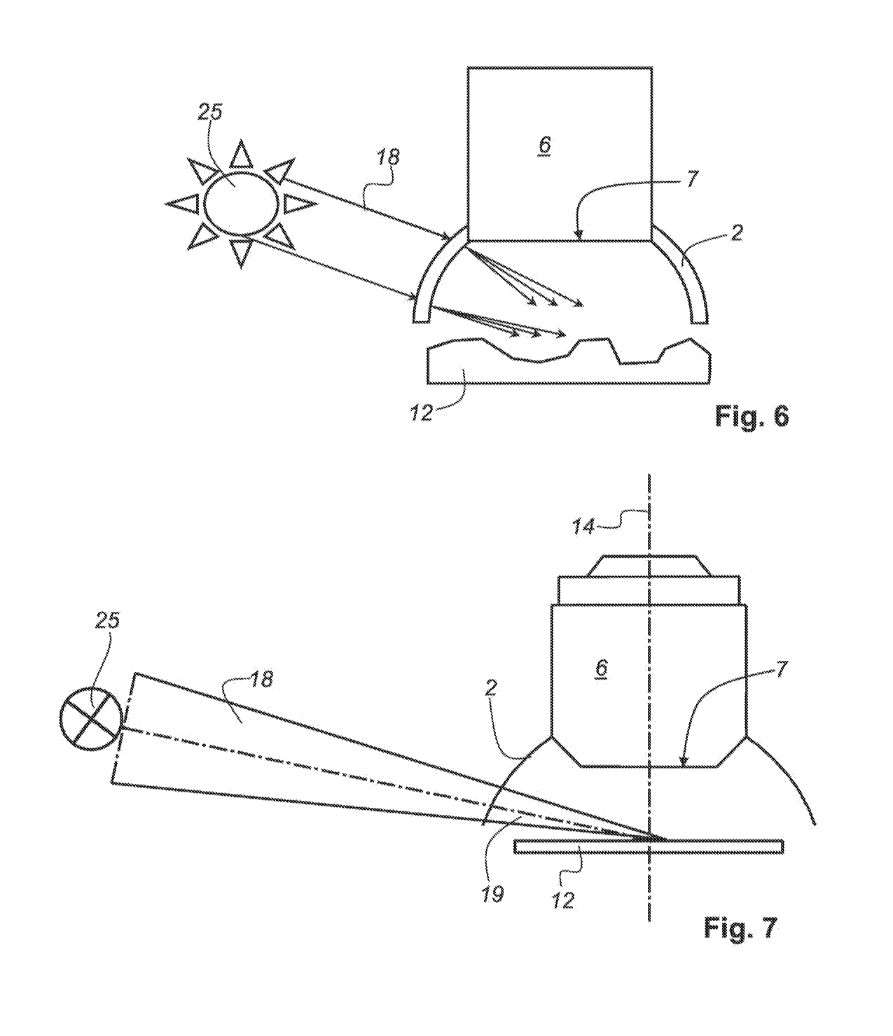

In FIG. 6 an embodiment of an objective lens 6 is shown, wherein the illumination of the object 12 is provided through the dome 2. According to the embodiment shown here, the additional light source 25 illuminates the dome 2 with external light 18 from the outside. In this case the dome 2 is made of transparent diffuse material. The external light 18 impinging on the dome 2, which is mounted at the free end 7 of the objective lens 6, is scattered towards the object 12.

FIG. 7 shows a preferred embodiment of the inventive set up shown in FIG. 6. Instead of using diffuse material for the dome 2 one can also use any wavelength converting material. An example is a phosphor which converts wavelength band λₑₓ±Δλₑₓ. of the external light 18 into an internal light 19 of the dome 2 with another wavelength band λₑₘ±Δλₑₘ. The external light source 25 provides the external light 18 in the blue wavelength band λₑₓ±Δλₑₓ. Preferably the external light source 25 is a ring light with at least one blue LED. The dome 2 transforms the external light 18 from the at least one blue LED into white internal light 19. In case the ring light does not illuminate the dome 2 evenly, one could change the ring light optics (not shown) or one could add beam shaping optics (not shown).

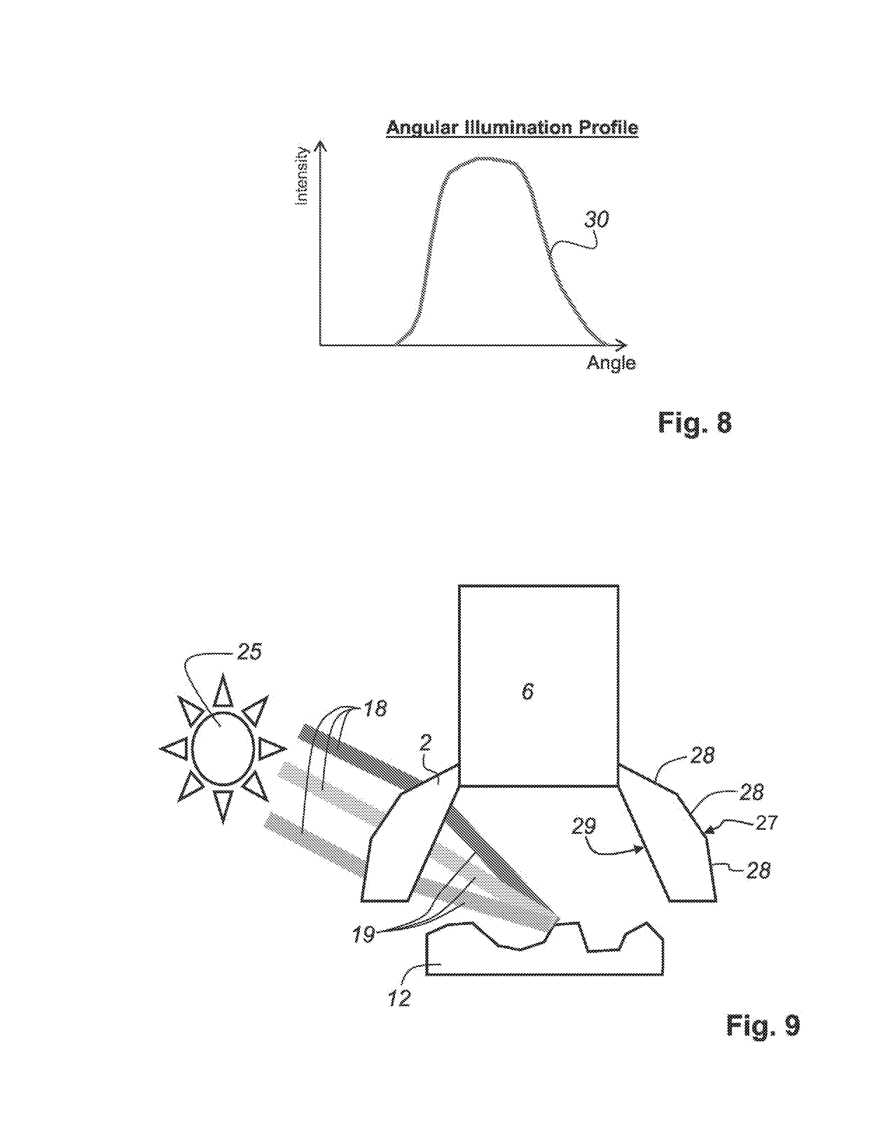

The angle distribution of the light 15 provided by the at least one light source 20 (see FIG. 2), The angle distribution of the light 18 provided by the at least one light source 25 (see FIG. 6) and the angle distribution of the internal light 19 provided by the external light source 25 (see FIG. 7), is shown in FIG. 8. All embodiments (FIG. 2, FIG. 6 and FIG. 7) will result in a diffuse illumination of the object 12. Hence the illumination will have a continuous profile 30 in angle.

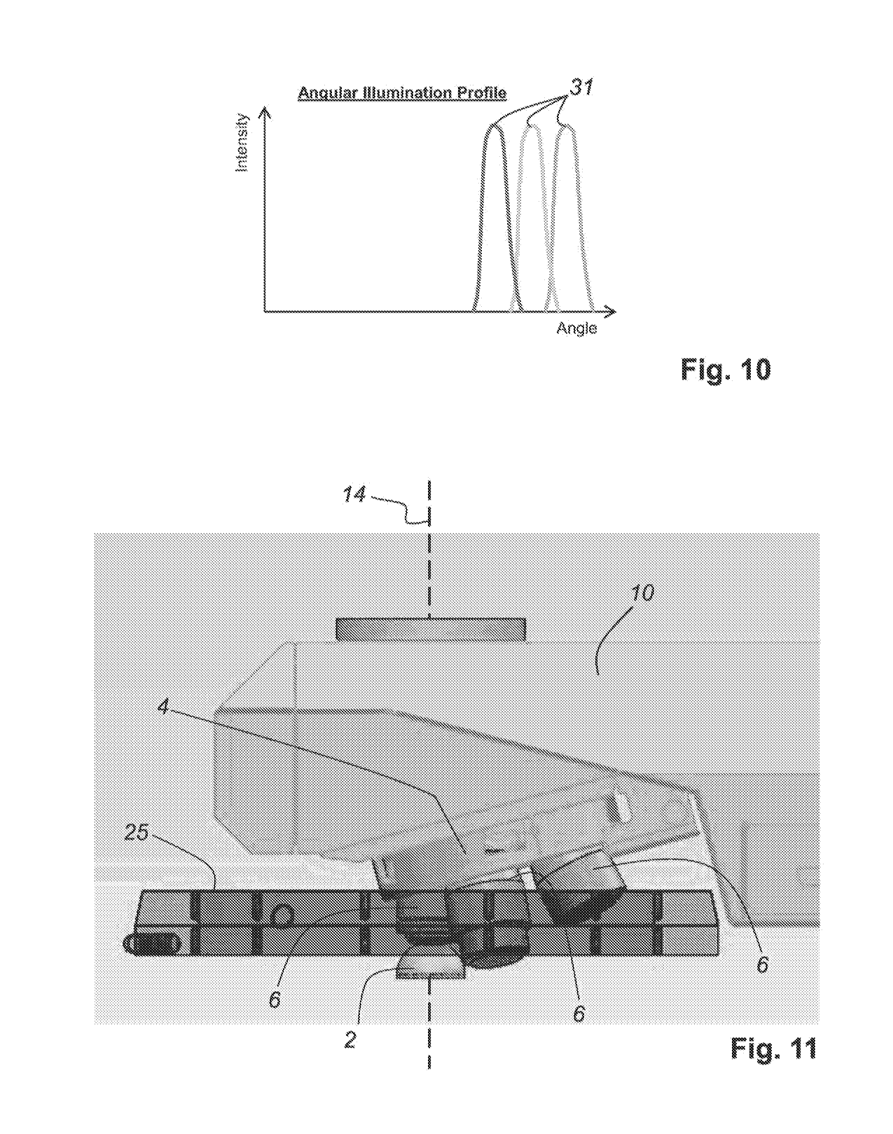

The embodiment shown in FIG. 9 also uses an external light source 25 which illuminates the dome 2. The dome 2 is made of a transparent material and has multiple facets 28. Each facet 28 refracts part of the impinging beam of external light 18 towards the object 12. The angle of each facet 28 determines the resulting angle of incidence of the internal light 19 on the object 12 while the size of the facet determines the size of the illuminated area on the object 12. The facets 28 can be on an outside 27 as well as on an inside 29 of the dome 2. In the simplest form the facets 28 are planar but also curved shapes are possible. With this type of dome 2 there are multiple degrees of freedom (facet size, shape, position, angle) which makes it possible to design the dome 2 for a wanted illumination profile. Since this dome 2 generates multiple beams at different angles the angular illumination profile in general will consist of multiple peaks 31 (see FIG. 10). Making the inner surface 29 of the dome 2 diffuse can help reaching a more continuous illumination profile. in case of the embodiment shown in FIG. 9 there is an additional benefit in the available degrees of freedom for the design. This gives high control over the resulting light distribution. On top of that this dome 2 relies on refraction rather than scattering. This makes it more efficient resulting in higher illumination levels.

FIG. 11 shows a microscope 10, wherein according to the embodiment shown here the external light source 25 is a ring light provided for illumination purposes. The microscope turret 4 of the microscope 10 carries a plurality of objective lenses 6. With the microscope turret 4 a desired objective lens 6 can be brought into a working position. The working position is defined by the optical axis 14 of the microscope 10. At least one objective lens 6 carries a dome 2.

The invention has been described with reference to specific embodiments. It is obvious to a person skilled in the art, however, alterations and modifications can be made without leaving the scope of the subsequent claims.

### REFERENCE NUMERALS

| | |
|---|---|
| 2 | dome |
| 4 | microscope turret |
| 6 | objective lenses |
| 7 | free end |
| 8 | working distance |
| 9 | height |
| 10 | microscope |
| 11 | surface |
| 12 | object |
| 13 | inner surface |
| 14 | optical axis |
| 15 | light |
| 16 | dark field illumination path |
| 17 | field of view |
| 18 | external light |
| 19 | internal light |
| 20 | least one light source |
| 22 | ring shaped mirror |
| 25 | additional light source |
| 25A | light spots |
| 25B | homogeneous illuminated ring |
| 27 | outside |
| 28 | facets |
| 29 | inside |
| 30 | continuous profile |
| 31 | multiple peaks |

What is claimed is:

1. An illumination for a microscope comprising:
at least one objective lens defining a free end which is facing a surface of an object;
a dome is mounted to the free end of the at least one objective lens; and
at least one light source is arranged such that an illumination is provided to the dome when the objective lens is positioned in an optical axis.

2. The illumination for a microscope of claim 1, wherein the objective lens has a ring shaped mirror arranged in a dark field illumination path, wherein a reflective surface of the ring shaped mirror is formed such that incident light from the at least one light source is reflected towards an inner surface of the dome.

3. The illumination for a microscope of claim 2, wherein the inner surface of the dome is coated with some highly reflective diffuse material and formed such that the light is scattered towards the object.

4. The illumination for a microscope of claim 2, wherein an additional light source is arranged such that light from the additional light source shines under the dome onto the surface of the object.

5. The illumination for a microscope of claim 4, wherein the additional light source is a ring light.

6. The illumination for a microscope of claim 2, wherein the dome is made from a highly reflective and diffuse material.

7. Illumination for a microscope of claim 1, wherein the at least one light source is an external light source being arranged such that an external light impinging on the dome is scattered towards the object.

8. The illumination for a microscope of claim 7, wherein the dome is made of transparent diffuse material.

9. The illumination for a microscope of claim 1, wherein the at least one light source is an external light source being arranged such that an external light impinging on the dome is scattered towards the object and the dome is made of a wavelength converting material.

10. The illumination for a microscope of claim 9, wherein the external light source is a ring light with at least one blue LED with a wavelength band λₑₓ±Δλₑₓ and the wavelength converting material of the dome provides a wavelength band λₑₘ±Δλₑₘ for the illumination of the object, wherein λₑₘ±Δλₑₘ≢λₑₓ±Δλₑₓ.

11. The illumination for a microscope of claim 1, wherein the at least one light source is an external light source being arranged such that an external light impinging on the dome is refracted towards the object and the dome is made of a transparent material with multiple facets.

12. The illumination for a microscope of claim 11, wherein each facet has a refracting power in order to refract part of the impinging beam of external light towards the object.

13. The illumination for a microscope of claim 11, wherein the facets are formed on an outside of the dome or on an inside of the dome.

14. The illumination for a microscope of claim 11, wherein an inner surface of the dome is diffuse.

15. The illumination for a microscope of claim 11, wherein the external light source is a ring light.

16. A microscope, comprising
a microscope turret carrying at least one objective lens, wherein the at least one objective lens is movable with the microscope turret into an optical axis of the microscope;
a dome, mounted to a free end of the at least one objective lens; and
an external light source arranged such that external light is provided to the dome when the objective lens is positioned at the optical axis of the microscope.

17. The microscope of claim 16, wherein an internal light source of the microscope provides light to a ring shaped mirror arranged in a dark field illumination path of the objective lens, wherein a reflective surface of the ring shaped mirror is formed such that incident light from the at least one internal light source is reflected towards an inner surface of the dome and the inner surface of the dome is coated with some highly reflective diffuse material and formed such that the light is scattered towards the object.

18. The microscope of claim 16, wherein the external light source is a ring light and arranged such that light from the ring light shines under the dome onto the surface of the object.

19. The microscope of claim 16, wherein the external light source is arranged such that an external light impinging on the dome is scattered towards the object and the dome is made of transparent diffuse material.

20. The microscope of claim 16, wherein the external light source is arranged such that an external light impinging on the dome is scattered towards the object and the dome is made of a wavelength converting material for converting a wavelength band λₑₓ±Δλₑₓ of the external light to a wavelength band λₑₘ±Δλₑₘ for the illumination of the object, wherein λₑₘ±Δλₑₘ≢λₑₓ±Δλₑₓ.

21. The microscope of claim 16, wherein the external light being arranged such that an external light impinges on the dome and the dome is made of a transparent material with multiple facets wherein each facet has a refracting power in order to refract part of the impinging beam of external light towards the object.
